(19) United States
(12) Patent Application Publication
(10) Pub. No.: US 2017/0150191 A1
(43) Pub. Date: May 25, 2017

(54) SYSTEM AND METHOD TO IDENTIFY AND AUTOMATICALLY RECONFIGURE DYNAMIC RANGE IN CONTENT PORTIONS OF VIDEO

(71) Applicant: Disney Enterprises, Inc., Burbank, CA (US)

(72) Inventors: Michael J. Strein, Oakdale, AL (US); Kenneth Michel, Brightwaters, NY (US)

(73) Assignee: Disney Enterprises, Inc.

(21) Appl. No.: 14/952,236

(22) Filed: Nov. 25, 2015

(51) Int. Cl. H04N 21/234; H04N 21/61; G06T 7/00

(52) U.S. Cl. CPC H04N 21/23418; G06T 7/0051; H04N 21/6125

(57) ABSTRACT

Systems and method of reconfiguring content portions of video prior to broadcast to end consumers are presented herein. High dynamic range (HDR) content portions may be mixed with non-HDR content portions in a video. Non-HDR content portions may be identified and reconfigure to increase its dynamic range to give a more seamless appearance and interaction with HDR content portions within the video. In some implementations, individual content portions may be reconfigured such that parameter values of content parameters having a bit depth corresponding to non-HDR content may be substituted with substitute values having a bit depth that correspond to HDR content and/or other content.

### FIELD OF THE DISCLOSURE

This disclosure relates to reconfiguring dynamic range in content portions of video prior to broadcast to end consumers.

### BACKGROUND

The color space and luminance level of television has generally unchanged since the beginning of color television. The color space used for both standard definition TV and HDTV is based around a subset of the chromaticity diagram of 1931 (CIE Chromaticity 1931). Other mediums, such as film or computer generated graphics, have had enhanced color space and luminance levels for some time, but delivery through the television medium has been impossible. Now, with advancements in televisions, new color space standards and methods for distribution have evolved allowing the delivery for both enhanced color space and elevated brightness to the home.

### SUMMARY

One aspect of the disclosure relates to a system configured for reconfiguring content portions of video prior to broadcast to end consumers. Individual content portions may have parameter values of content parameters. The parameter values may convey a content type of the individual content portions. Individual values of content parameters may be expressed as bit strings and/or other information. A content type of a content portion may be determined based on a bit depth of individual parameter values. Content type may be associated with dynamic range of an individual content portion.

Dynamic range may include one or more of low dynamic range, standard dynamic range, high dynamic range, and/or other dynamic range. Individual content portions may be reconfigured such that values of individual content parameters having a bit depth corresponding to low- and/or standard-dynamic range content may be substituted with substitute values having a bit depth that correspond to high and/or other dynamic range content.

In some implementations, the system may include one or more physical processors configured by machine-readable instructions. Executing the machine-readable instructions may cause the one or more physical processors to facilitate reconfiguring content parameters of video. The machine-readable instructions may include one or more of a video component, a value determination component, a content type component, a reconfiguration component, a transmission component, and/or other components.

The video component may be configured to obtain one or more videos from one or more video sources prior to broadcast to end consumers. A video source may comprise one or more of a video library or archive, content creation or origination studio, an editing facility, a broadcast station, distribution center, a control room, and/or other sources. A video may be comprised of images generated from one or more of a video camera, film camera, a computer (e.g., electronically generated images such as CGI, virtual images, and/or other computer generated images), and/or from other techniques. These images may be combined and/or edited into a sequence to define the video. A video may include one or more content portions. By way of non-limiting example, a video may include one or more of a first content portion, a second content portion, and/or other content portions.

The value determination component may be configured to determine parameter values of content parameters for individual content portions of a video. By way of non-limiting example, the value determination component may be configured to determine one or more of a first set of parameter values for the first content portion, a second set of parameter values for the second content portion, and/or other parameter value for other content portions.

The content type component may be configured to identify content types of individual content portions based on the determined parameter values and/or other information. By way of non-limiting example, the content type component may be configured to identify a first content type of the first content portion based on the first set of parameter values, a second content type of the second content portion based on the second set of parameter values, and/or other content types for other content portions.

The reconfiguration component may be configured to reconfigure individual content portions of the first content type and/or other content types to be of the second content type and/or other content types. Reconfiguration may comprise substituting parameter values of the content parameters. By way of non-limiting example, the reconfiguration component may be configured to reconfigure the first content portion to be of the second content type by substituting the first set of parameter values for a third set of parameter values, and/or reconfigure other content portions. In some implementations, the third set of parameter values may correspond to the second content type.

The transmission component may be configured to effectuate transmission of the video having the first content portion, second content portion, and/or other content portions being of the second content type and/or other content types for broadcast to the end consumers.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for reconfiguring content portions of video prior to broadcast to end consumers, in accordance with one or more implementations.

FIG. 2 illustrates a method of reconfiguring content portions of video prior to broadcast to end consumers, in accordance with one or more implementations.

### DETAILED DESCRIPTION

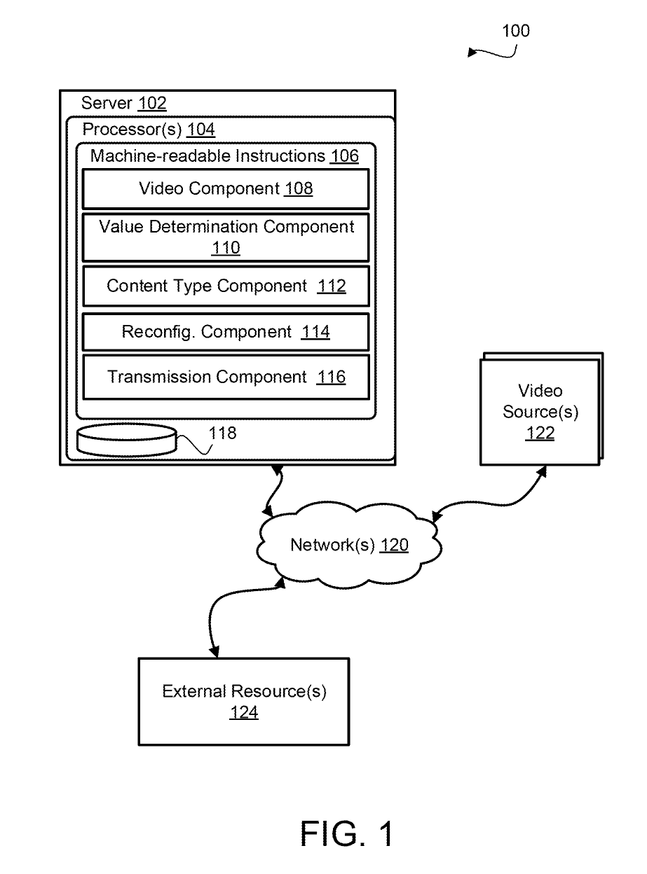

FIG. 1 illustrates a system 100 configured for reconfiguring content portions of video prior to broadcast to end consumers, in accordance with one or more implementations. A video may comprise one or more of a recorded video, a video stream, a live video feed, and/or other audiovisual asset. In some implementations, the system 100 may be configured to reconfigure individual content portions such that the individual reconfigured content portion's dynamic range may be expanded. By way of non-limiting example, individual content portions may be expanded along one or more of a primary or secondary color matrices, along a luminance axis, and/or other reconfiguration including using sophisticated methods such as tone mapping to give an appearance of a higher dynamic range for individual content portions.

In a high dynamic range (HDR) domain there may be many more bits of information to work with to facilitate enhancing one or more of color, brightness, contrast, and/or other visual aspects of a video. HDR content may be distinguishable from non-HDR content by the nature of it having a greater bit depth, as may be determined in a broadcast signal and/or source electronic file that may represented the video. Generally, system 100 may be configured to identify non-HDR content portions and reconfigure such content to increase its dynamic range to give a more seamless appearance and interaction with HDR content portions within the video. In some implementations, individual content portions may be reconfigured such that parameter values of content parameters having a bit depth corresponding to low- and/or standard-dynamic range content may be substituted with substitute values having a bit depth that correspond to high and/or other dynamic range content.

In some implementations, system 100 may comprise one or more of a server 102, one or more video sources 122, one or more external resources 124, and/or other components. The server 102 may include one or more physical processors 104 configured by machine-readable instructions 106. Executing the machine-readable instructions 106 may cause the one or more physical processors 104 to facilitate reconfiguring content portions of video prior to broadcast to end consumers. The machine-readable instructions 106 may include one or more of a video component 108, a value determination component 110, a content type component 112, a reconfiguration component 114 (abbreviate “Reconfig. Component 114” in FIG. 1), a transmission component 116, and/or other components.

It is noted that in some implementations, features and/or functions attributed to server 102 may be accomplished by other devices and/or computing platforms. By way of non-limiting example, a computing platform may include one or more physical processor configured by machine-readable instructions. The machine-readable instructions of a computing platform may include the same or similar machine-readable instructions as server 102. A computing platform may include one or more of a cellular telephone, a smartphone, a digital camera, a laptop, a tablet computer, a desktop computer, a television set-top box, smart TV, a gaming console, and/or other platforms.

The video component 108 may be configured to obtain video prior to broadcast to end consumers. The video component 108 may obtain video from one or more video sources 122. In some implementations, a video source 122 may comprise one or more of a video library or archive, content creation or origination studio, an editing facility, a broadcast station, distribution center, a control room, and/or other sources. It is noted that a source from which video component 108 may include one or more entities that may participate in pre-broadcast communications of video.

Individual videos may be represented by one or more of a broadcast signal, a source electronic file, and/or other information. A broadcast signal may include information that may be readable by an end consumer device to effectuate presentation of the video at a display of the end consumer device, and/or other information. An end consumer device may comprise one or more of a television set, a smart TV, a smartphone, a desktop computer, and/or other end consumer devices. A source electronic file may include source computer code and/or other information that may represent a video prior to broadcast to an end consumer device.

A video may include visual information, audio information, and/or other information. Audio information may define one or more of a sound track, musical score, commentary, voice over track, and/or other audio component of a video. Visual information may define individual pixels of the video that may be presented at individual frames of the video. Visual information may include parameter values of one or more content parameters that may define individual pixels of the video. Video obtained by video component 108 may have a resolution associated with one or more of SDTV (Standard Definition Television), HDTV (High Definition Television), UHDTV (Ultra High Definition TV—also known as 4K), Computer Graphics Generation (CGI), digital film intermediaries, and/or other resolutions.

In some implementations, content parameters may include one or more of primary color parameters, secondary color parameters, luminance parameters, non-linearity curve parameters, clip parameters, and/or other parameters.

Values of primary color parameters may define primary color components of individual pixels. Primary color components may include one or more of a first primary color component, a second primary color component, a third primary color component, and/or other primary color components. In some implementations, primary color parameters may include one or more of a first primary color parameter, a second primary color parameter, a third primary color parameter, and/or other primary color parameters. A value of the first primary color parameter of an individual pixel may define the first primary color component and/or other primary color component of the individual pixel. A value of the second primary color parameter of an individual pixel may define the second primary color component and/or other primary color component of the individual pixel. A value of the third primary color parameter of an individual pixel may define the third primary color component and/or other primary color component of the individual pixel.

By way of non-limiting illustration, the first primary color parameter may comprise a red primary color parameter. A value of the red primary color parameter of an individual pixel may define a red color component and/or other primary color component of the individual pixel. The second primary color parameter may comprise a green primary color parameter. A value of the green primary color parameter of an individual pixel may define a green color component and/or other color component of the individual pixel. The third primary color parameter may comprise a blue primary color parameter. A value of the blue primary color parameter of an individual pixel may define a blue color component and/or other color component of the individual pixel.

It is noted that the above description of primary color components and/or parameters are provided for illustrative purposes only is not to be considered limiting. By way of non-limiting example, in some implementations, primary color parameters may be used to define more, fewer, and/or other primary color components of individual pixels.

Values of secondary color parameters may define secondary color components of individual pixels. Secondary color components may include one or more of a first secondary color component, a second secondary color component, a third secondary color component, and/or other secondary color components. In some implementations, the secondary color parameters may include one or more of a first secondary color parameter, a second secondary color parameter, a third secondary color parameter, and/or other secondary color parameters. A value of the first secondary color parameter of an individual pixel may define the first secondary color component and/or other secondary color component of the individual pixel. A value of the second secondary color parameter of an individual pixel may define the second secondary color component and/or other secondary color component of the individual pixel. A value of the third secondary color parameter of an individual pixel may define the third secondary color component and/or other secondary color component of the individual pixel.

By way of non-limiting illustration, the first secondary color parameter may comprise a yellow secondary color parameter. A value of the yellow secondary color parameter of an individual pixel for an individual pixel may define a yellow color component and/or other secondary color component of the individual pixel. The second secondary color parameter may comprise a magenta secondary color parameter. A value of the magenta secondary primary color parameter of an individual pixel may define a magenta color component and/or other color component of the individual pixel. The third secondary color parameter may comprise a cyan secondary color parameter. A value of the cyan secondary color parameter of an individual pixel may define a cyan color component and/or other color component of the individual pixel.

It is noted that the above description of secondary color components and/or parameters are provided for illustrative purposes only is not to be considered limiting. By way of non-limiting example, in some implementations, secondary color parameters may be used to define more, fewer, and/or other secondary color components of individual pixels.

Values of luminance parameters may define a luminous intensity of individual pixels. Luminous intensity may dictate how bright an individual pixel may appear. In some implementations, luminance intensity may correspond to one or more of peak white luminance levels, minimum black luminance levels, and/or other aspects of individual pixels. By way of non-limiting example a value of a luminance parameter of an individual pixel may define a luminous intensity of the individual pixel.

Values of non-linearity curve parameters may define one or more of a gamma curve, and/or other non-linearity curve that may represent other display aspects of video. By way of non-limiting example, a gamma curve may define a balance between bright and dark areas of the video. Certain luminance ranges may be more sensitive to the eye in terms of the visibility of quantizing steps. For example, dark (low luminance) regions may not be so noticeable, so those regions may be assigned less bits, while higher luminance (brighter) regions may be assigned more bits. As the curve bends, this may be referred to as the “knee” in the curve. Non-linear curves such as these may originate in an acquisition device, such as a camera, and may be defined by an OETF (optical electrical transfer function). Often a complementary curve may be present before and/or within the display device, known as the EOTF (electrical optical transfer function). The EOTF may facilitate translating the desired curve to the display device. Other types of curves exist as well, including the Barten curve, which illustrates the GSDF (Gray Scale Display Function), defining the perceptual steps in luminance ranges.

Values of clip parameters may define one or both of white and/or black clip levels of individual pixels. In some implementations, white and/or black clip levels may be set to control the exposure of individual pixels (e.g., prevent or reduce overexposure).

Values of individual content parameters may be expressed as bit strings, and/or other information. A value of an individual content parameter may have a bit depth corresponding to the number of bits in the bit string. The bit depth of an individual value may convey a content type of an individual video portion. Content type may be associated with dynamic range of an individual video portion. By way of non-limiting example, low dynamic range may be associated with a bit depth under 8-bits, and/or other bit range. A standard dynamic range may be associated with a bit depth of about 8-bits, and/or other bit depths. High dynamic range may be associated with a bit depth between 10 and 24 bits and/or other range.

By way of non-limiting illustration, video component 108 may be configured to obtain a video comprising one or more of a first content portion, a second content portion, and/or other content portions. In some implementations, the first content portion may comprise interstitial content (e.g., a commercial and/or other interstitial content), and/or other content. In some implementations, the second content portion may comprise primary content (e.g., a movie, a television show, and/or other primary content) and/or other content. It is noted that the video may include one or more additional content portions comprising interstitial content and/or primary content. By way of non-limiting illustration, a video may comprise a movie and/or television show that may alternate between content of the movie and/or television show (e.g., primary content) and commercial breaks (e.g., interstitial content).

The value determination component 110 may be configured to determine parameter values of content parameters for individual content portions of the video. Parameter values may be determined from one or both of a broadcast signal and/or source electronic file that may represented the video. The value determination component 110 may be configured to determine sets of parameter values wherein individual parameter values may define individual pixels to be displayed at individual frames of the video.

By way of non-limiting example, value determination component 110 may be configured to determine one or more of a first set of parameter values for the first content portion, a second set of parameter values for the second content portion, and/or other parameter values for other content portions. Individual values in the first set of values may be expressed as bit strings of a first bit depth and/or other bit depth. Individual values in the second set of values may be expressed as bit strings of a second bit depth and/or other bit depth. In some implementations, the first bit depth may be less than the second bit depth.

The content type component 112 may be configured to identify content types of individual content portions based on the determined parameter values. As described herein, content type may be identified based on a bit depth of individual parameter values. By way of non-limiting example, the first bit depth and/or other bit depths of parameter values may correspond to a first content type and/or other content type. The first content type may comprise one or more of low dynamic range, standard dynamic range, and/or other dynamic ranges. The second bit depth and/or other bit depths may correspond to a second content type and/or other content type. The second content type may comprise one or more of high dynamic range and/or other dynamic ranges.

By way of non-limiting example, content type component 112 may be configured to identify one or more of the first content portion as the first content type based on the first set of parameter values, the second content portion as the second content type based on the second set of parameter values, and/or other content types of other content portions based on parameter values of the content portions.

The reconfiguration component 114 may be configured to reconfigure individual content portions. In some implementations, reconfiguration may comprise substituting parameter values that are of a bit depth that corresponds to low and/or standard dynamic range with substitute parameter values that are of a bit depth that corresponds to high dynamic range content, and/or other techniques. Reconfiguration may facilitate an expansion of the individual content portion's dynamic range to within a range comparable to high and/or dynamic range content.

In some implementations, substitute parameter values may be determined based on one or more techniques. The techniques may include one or more of linear stretching (expansion) of the determined parameter values, non-linear stretching, tone mapping using lookup tables, and/or other techniques. By way of non-limiting example, non-linear stretching may use one or more sets of gamma curves, OETF/EOTF curves and/or other such curves that may accentuate a luminance portion and/or other portions of the curve (e.g., potentially in the lower black region or higher white region where the eye may be more sensitive to “stepping” or visual quantizing levels that appear as banding).

It is noted that the above techniques for determining substitute parameter values are provided for illustrative purposes only and are not to be considered limiting. For example, in some implementations, other techniques for determining substitute parameter values to increase a video's dynamic range may be employed.

By way of non-limiting example, the reconfiguration component 114 may be configured to reconfigure the first content portion and/or other content portions to be of the second content type and/or other content types. Reconfiguring the first content portion may comprise substituting the first set of parameter values for a third set of parameter values and/or other parameter values. Individual parameter values in the third set of parameter values may correspond to the second content type and/or other content types. For example, individual parameter values in the third set of parameter values may be expressed as a bit string having the second bit depth and/or other bit depths.

The transmission component 116 may be configured to effectuate transmission of video for broadcast to end consumers. The transmission component 116 may be configured to effectuate transmission once one or more content portions of a non-HDR content type have been reconfigured to an HDR content type. In some implementations, transmitting video for broadcast to consumers may comprise transmitting the video back into one or more pre-broadcast stages of video broadcast (e.g., to one or more video sources 122) and/or transmitting video directly to end consumer devices.

By way of non-limiting example, transmission component 116 may be configured to effectuate transmission of the video having the reconfigured first content portion, the second content portion, and/or other content portions being of the second content type for broadcast to the end consumers.

Returning to FIG. 1, the server 102, video sources 122, and/or external resources 124 may be operatively linked via one or more electronic communication links. For example, such electronic communication links may be established, at least in part, via one or more networks 120. Network (120) may comprise wired and/or wireless networks. By way of non-limiting example, Network(s) 120 may comprise one or more of the Internet, television broadcast network, direct to home (DTH) satellite network, multiple video program distributor network (MVPD) and/or other networks. It will be appreciated that this is not intended to be limiting and that the scope of this disclosure includes implementations in which server 102, video sources 122, and/or external resources 124 may be operatively linked via some other communication media.

The external resources 124 may include sources of information, hosts, external entities participating with system 100, and/or other resources. In some implementations, some or all of the functionality attributed herein to external resources 124 may be provided by resources included in system 100. By way of non-limiting example, external resources 124 may comprise one or more of end consumer devices, computing platform attributed with one or more features and/or functions described herein with respect to server 102, and/or other entities.

The server 102 may include electronic storage 118, one or more processors 104, and/or other components. The server 102 may include communication lines or ports to enable the exchange of information with a network and/or other computing platforms. Illustration of server 102 in FIG. 1 is not intended to be limiting. The server 102 may include a plurality of hardware, software, and/or firmware components operating together to provide the functionality attributed herein to server 102. For example, server 102 may be implemented by a cloud of computing platforms operating together as server 102.

Electronic storage 118 may comprise electronic storage media that may electronically store information. The electronic storage media of electronic storage 118 may include one or both of system storage that is provided integrally (i.e., substantially non-removable) with server 102 and/or removable storage that is removably connectable to server 102 via, for example, a port or a drive. A port may include a USB port, a firewire port, and/or other port. A drive may include a disk drive and/or other drive. Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 118 may include one or more virtual storage resources (e.g., cloud storage, a virtual private network, and/or other virtual storage resources). Electronic storage 118 may store software algorithms, information determined by processor 104, information received from server 102, information received from computing platforms 122, and/or other information that enables server 102 to function as described herein.

Processor(s) 104 is/are configured to provide information-processing capabilities in server 102. As such, processor 104 may include one or more of a digital processor, an analog processor, a digital circuit designed to process information, an analog circuit designed to process information, a state machine, and/or other mechanisms for electronically processing information. Although processor 104 is shown in FIG. 1 as a single entity, this is for illustrative purposes only. In some implementations, processor 104 may include one or more processing units. These processing units may be physically located within the same device, or processor 104 may represent processing functionality of a plurality of devices operating in coordination. The processor 104 may be configured to execute components 108, 110, 112, 114, and/or 116. Processor 104 may be configured to execute components 108, 110, 112, 114, and/or 116 by software; hardware; firmware; some combination of software, hardware, and/or firmware; and/or other mechanisms for configuring processing capabilities on processor 104.

It should be appreciated that although components 108, 110, 112, 114, and/or 116 are illustrated in FIG. 1 as being co-located within a single processing unit, in implementations in which processor 104 includes multiple processing units, one or more of components 108, 110, 112, 114, and/or 116 may be located remotely from the other components. The description of the functionality provided by the different components 108, 110, 112, 114, and/or 116 described above is for illustrative purposes and is not intended to be limiting, as any of components 108, 110, 112, 114, and/or 116 may provide more or less functionality than is described. For example, one or more of components 108, 110, 112, 114, and/or 116 may be eliminated, and some or all of its functionality may be provided by other ones of components 108, 110, 112, 114, 116, and/or other components. As another example, processor 104 may be configured to execute one or more additional components that may perform some or all of the functionality attributed below to one of components 108, 110, 112, 114, and/or 116.

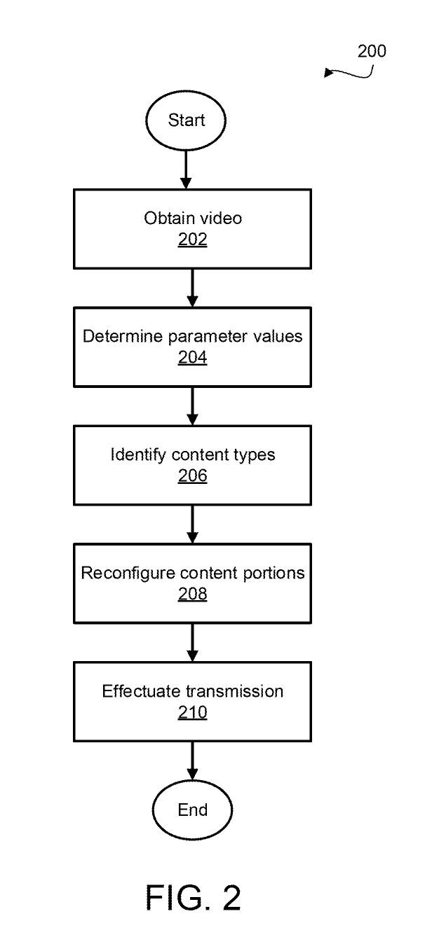

FIG. 2 illustrates a method 200 of reconfiguring content portions of video prior to broadcast to end consumers. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in a computer system comprising one or more of one or more processing devices (e.g., a digital processor, an analog processor, a digital circuit designed to process information, an analog circuit designed to process information, a state machine, and/or other mechanisms for electronically processing information), electronic storage media, and/or other components. The one or more processing devices may include one or more devices executing some or all of the operations of method 200 in response to instructions stored electronically on electronic storage media. The one or more processing devices may include one or more devices configured through hardware, firmware, and/or software to be specifically designed for execution of one or more of the operations of method 200.

At an operation 202, a video may be obtained prior to broadcast to end consumers. The video may include content portions having parameter values of content parameters. By way of non-limiting example, the video may comprise a first content portion, a second content portion, and/or other content portions. In some implementations, operation 202 may be performed by one or more physical processors executing a video component the same as or similar to video component 108 (shown in FIG. 1 and described herein).

At an operation 204, parameter values of content parameters for individual content portions of the video may be determined. By way of non-limiting example, a first set of parameter values may be determined for the first content portion. A second set of parameter values may be determined for the second content portion. Other parameter values may be determined for other content portions. In some implementations, operation 204 may be performed by one or more physical processors executing a value determination component the same as or similar to value determination component 110 (shown in FIG. 1 and described herein).

At an operation 206, content types of individual content portions may be identified based on the determined parameter values. By way of non-limiting example, a first content type may be identified for the first content portion based on the first set of parameter values. A second content type may be identified for the second content portion based on the second set of parameter values. Other content types may be identified for other content portions. In some implementations, operation 206 may be performed by one or more physical processors executing a content type component the same as or similar to the content type component 112 (shown in FIG. 1 and described herein).

At an operation 208, individual content portions of the first content type and/or other content types may be reconfigured to be of the second content type and/or other content types. Reconfiguration may comprise substituting parameter values of the content parameters and/or other techniques. By way of non-limiting example, the first content portion may be reconfigured to the second content type by substituting the first set of parameter values for a third set of parameter values and/or other parameter values. The third set of parameter values may correspond to the second content type. In some implementations, operation 208 may be performed by one or more physical processors executing a reconfiguration component the same as or similar to the reconfiguration component 114 (shown in FIG. 1 and described herein).

At an operation 210, transmission of the video having content portions of the second content type and/or other content types may be effectuated. By way of non-limiting example, the transmission of the video having the reconfigured first content portion, second content portion, and/or other content portions being of the second content type may be effectuated for broadcast to the end consumers. In some implementations, operation 210 may be performed by one or more physical processors executing a transmission component the same as or similar to the transmission component 116 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for reconfiguring content portions of video prior to broadcast to end consumers, the system comprising:
one or more physical processors configured by machine-readable instructions to:
obtain a video prior to broadcast to end consumers, the video including content portions having parameter values of content parameters, the video comprising a first content portion and a second content portion;
determine parameter values of content parameters for individual content portions of the video, such determination including a first set of parameter values for the first content portion and a second set of parameter values for the second content portion;
identify content types of individual content portions based on the determined parameter values, such identification including a first content type of the first content portion based on the first set of parameter values, and a second content type of the second content portion based on the second set of parameter values;
reconfigure individual content portions of the first content type to be of the second content type by substituting parameter values of the content parameters, the first content portion being reconfigured to the second content type by substituting the first set of parameter values for a third set of parameter values, the third set of parameter values corresponding to the second content type; and
effectuate transmission of the video having the first content portion and second content portion being of the second content type for broadcast to the end consumers.

2. The system of claim 1, wherein the video comprises a broadcast signal or an electronic file.

3. The system of claim 1, wherein content parameters comprise one or more of a primary color parameter, a secondary color parameter, a non-linearity curve parameter, a clip parameter, or a luminance parameter.

4. The system of claim 1, wherein individual parameter values of individual content parameters are expressed as bit strings, wherein individual parameter values in the first set of parameters are expressed a bit string of a first bit depth, wherein individual parameter values in the second set and third set of parameter values are expressed as a bit string of a second bit depth, and wherein the first bit depth is less than the second bit depth.

5. The system of claim 4, wherein individual content types are identified based on a dynamic range of an individual content portion, and wherein the dynamic range is determined based on the bit depth of individual parameter values of content parameters.

6. The system of claim 5, wherein the first content type is low dynamic range content or a standard dynamic range content.

7. The system of claim 5, wherein the second content type is high dynamic range content.

8. The system of claim 1, wherein an individual video content portion includes one of primary content or interstitial content.

9. The system of claim 1, wherein the video is obtained from one or more of a distribution center, a video library, an editing facility, a broadcast center, a studio, or a control room.

10. A method of reconfiguring content portions of video prior to broadcast to end consumers, the method being implemented in a computer system comprising one or more physical processors and storage media storing machine-readable instructions, the method comprising:
obtaining a video prior to broadcast to end consumers, the video including content portions having parameter values of content parameters, the video comprising a first content portion and a second content portion;
determining parameter values of content parameters for individual content portions of the video, including determining a first set of parameter values for the first content portion and a second set of parameter values for the second content portion;
identifying content types of individual content portions based on the determined parameter values, including identifying a first content type of the first content portion based on the first set of parameter values, and a second content type of the second content portion based on the second set of parameter values;
reconfiguring individual content portions of the first content type to be of the second content type by substituting parameter values of the content parameters, the first content portion being reconfigured to the second content type by substituting the first set of parameter values for a third set of parameter values, the third set of parameter values corresponding to the second content type; and
effectuating transmission of the video having the first content portion and second content portion being of the second content type for broadcast to the end consumers.

11. The method of claim 10, wherein the video comprises a broadcast signal or an electronic file.

12. The method of claim 10, wherein content parameters comprise one or more of a primary color parameter, a secondary color parameter, a non-linearity curve parameter, a clip parameter, or a luminance parameter.

13. The method of claim 10, wherein individual parameter values of individual content parameters are expressed as bit strings, wherein individual parameter values in the first set of parameters are expressed a bit string of a first bit depth, wherein individual parameter values in the second set and third set of parameter values are expressed as a bit string of a second bit depth, and wherein the first bit depth is less than the second bit depth.

14. The method of claim 13, wherein identifying individual content types is based on a dynamic range of an individual content portion, and wherein the dynamic range is determined based on the bit depth of individual parameter values of content parameters.

15. The method of claim 14, wherein the first content type is low dynamic range content or a standard dynamic range content.

16. The method of claim 14, wherein the second content type is high dynamic range content.

17. The method of claim 10, wherein an individual video content portion includes one of primary content or interstitial content.

18. The method of claim 10, wherein the video is obtained from one or more of a distribution center, a video library, an editing facility, a broadcast center, a studio, or a control room.
